(19) United States
(12) Patent Application Publication
(10) Pub. No.: US 2008/0251213 A1
(43) Pub. Date: Oct. 16, 2008

(54) AUTOMATIC SPONGE BONDING APPARATUS FOR FACE MASK

(76) Inventor: Hung-Ho CHEN, Tu Cheng City (TW)

Correspondence Address: LEONG C LEI, PMB # 1008, 1867 YGNACIO VALLEY ROAD, WALNUT CREEK, CA, 94598, US

(21) Appl. No.: 11/735,500

(22) Filed: Apr. 16, 2007

(51) Int. Cl. B32B 37/00; B29C 65/00

(52) U.S. Cl. 156/510; 156/538

(57) ABSTRACT

An automatic sponge bonding apparatus for a face mask is disclosed, including a conveyance carrier, a sponge cutting device, a sponge pickup mechanism, a first sponge pressing mechanism, and a second sponge pressing mechanism. The carrier conveys the mask along an operation platform to carry out attachment of a sponge member to the mask on the platform, while the sponge member is being prepared on the platform by being properly cut. Two pressing operations are employed to attach and secure the cut sponge to mask to eventually realize automatic operation of attaching the sponge member to the face mask.

### BACKGROUND OF THE INVENTION

(a) Technical Field of the Invention

The present invention relates to an apparatus for bonding a sponge member to a face mask, and in particularly to an apparatus that automatically picks up a sponge member and attach the sponge member so picked up to a face mask.

(b) Description of the Prior Art

Due the air pollution caused by modernization and industrialization, face masks are more and more often used by urban people. However, conventionally, the face masks can only be manufactured in a semi-automation manner, especially for attaching a sponge member to a mask body. Thus, a great amount of human labor is needed in making the face mask. As a consequence, costs cannot be reduced and throughput cannot be enhanced. Since the sponge member attached to the mask helps making the mask wearer feel comfortable in wearing the mask, attaching the sponge to the mask is a necessary step that must be automatized to enhance the production of the face masks.

Thus, the present invention is aimed to overcome the above discussed problems by providing an apparatus capable of automatically attaching a sponge member to a body of a face mask.

### SUMMARY OF THE INVENTION

The primary purpose of the present invention is to provide an automatic sponge bonding apparatus for a face mask, comprising: a conveyance carrier, a sponge cutting device, a sponge pickup mechanism, a first sponge pressing mechanism, and a second sponge pressing mechanism, wherein the sponge cutting device serves to cut a length of sponge into cut pieces of sponge and comprises at least one cut roller and at least one forward roller. The cut roller is provided with at least one cut blade. The forward roller functions to drive the sponge and to separate a back adhesive release film from a back adhesive layer of the sponge. A conveyance belt is arranged behind the forward roller to convey a cut sponge piece. Further, at least one sponge retention bar is arranged above the conveyance belt for pressing and thus retaining the cut sponge piece. The sponge pickup mechanism comprises a pickup frame, a pickup arm, a pickup clip, a shaped, anvil slide, and a shaped anvil and functions to pick up and transfer the cut sponge piece. A sponge holding mechanism is provided by one side of the anvil and comprises a retention clamp, a resilient member, and a push board. The anvil is driven toward the pickup clip that grips a cut sponge piece to press against the sponge piece so that the sponge piece is retained on the anvil by the sponge holding mechanism. The anvil is then rotated to face the inside of the mask to thereby form the first, pressing mechanism with a press board for adhesively attaching the sponge piece to the mask, wherein the press board arranged outside the conveyance carrier is moved toward and pressing against the mask, and at the same time, the anvil is moved down to abut against the inside of the mask so as to allow the sponge piece to be fixed to the mask. Then the second sponge pressing mechanism is employed to perform a second pressing operation to more tightly attach the sponge piece to the inside of the mask. The second sponge pressing mechanism comprises a pair of rollers and a shaping board. The shaping board can be lowered down to the inside of the mask, and the rollers can roll and press the mask against an outer contour of the shaping board to carry out the second pressing of the sponge piece to the mask. Further, the automatic sponge bonding apparatus of the present invention comprises a mask holder and a mask spreading mechanism, wherein the mask holder serves to support a mask in a folded condition and the wherein the mask spreading mechanism comprises at least one spreading arm and a clamp for gripping the folded mask positioned on the mask holder and to picks up and spreads the mask to change the mask to a spread and then to put the mask onto the conveyance carrier. The conveyance carrier comprises a carrier chassis and at least one roller, which is coupled to the chassis. A retention plate is arranged on the chassis for pressing and retaining the mask on the carrier in the spread condition.

The apparatus employs the conveyance carrier to convey the face mask and carries out the bonding of the sponge piece to the mask on the platform of the apparatus, and at the same time, the sponge piece is being prepared on the platform. Finally, two pressing operations are used to firmly attach the sponge to the mask with enhanced firmness.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1A-1E illustrate the operation of a mask spreading mechanism of an automatic sponge bonding apparatus constructed in accordance with the present invention;

FIGS. 2A and 2B illustrate the operation of a sponge cutting device of the automatic sponge bonding apparatus of the present invention;

FIGS. 3A-3K illustrate the operation of a sponge pickup mechanism of the automatic sponge bonding apparatus of the present invention;

FIGS. 4A and 4B illustrate the operation of a first sponge pressing mechanism of the automatic sponge bonding apparatus of the present invention;

FIGS. 5A and 5B illustrate the operation of a second sponge pressing mechanism of the automatic sponge bonding apparatus of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

With reference to the drawings, an automatic sponge bonding apparatus constructed in accordance with the present invention generally comprises a mask spreading mechanism 120, a mask holder 126, a conveyance carrier 140, a sponge cutting device 200, a sponge pickup mechanism 300, a first sponge pressing mechanism 400, and a second sponge pressing mechanism 500, all of winch cooperate to realize automatic bonding of a sponge member to a face mask. These devices/mechanisms will be described in details in the following description.

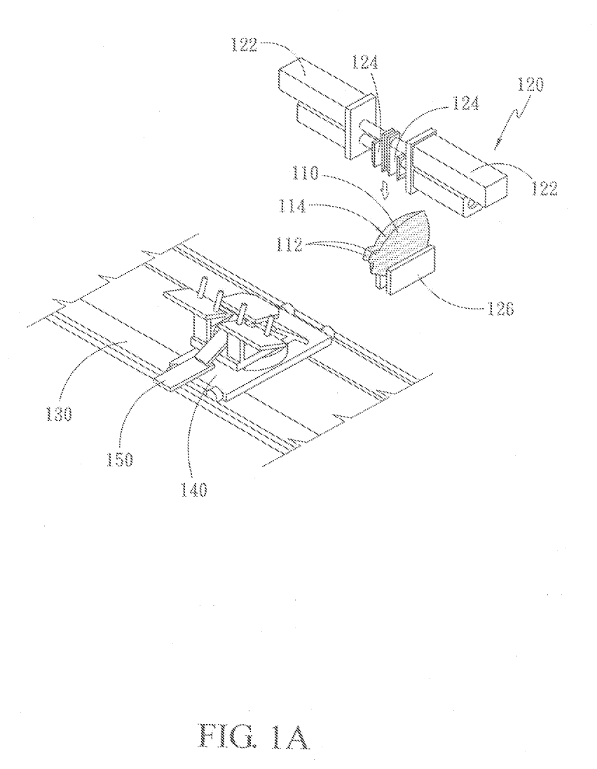

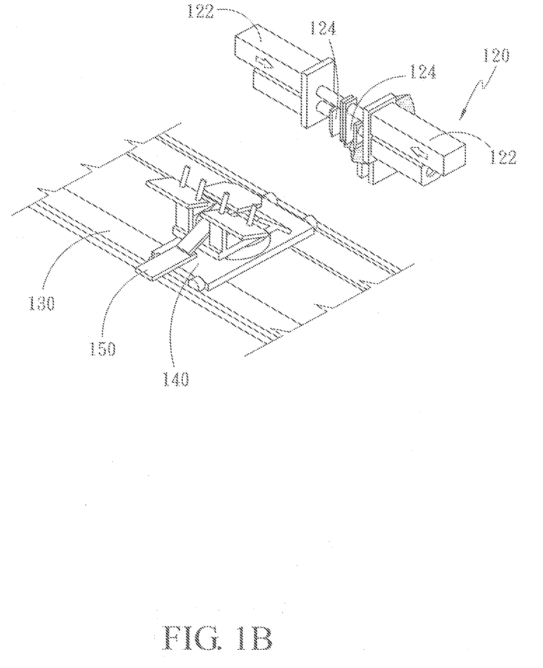

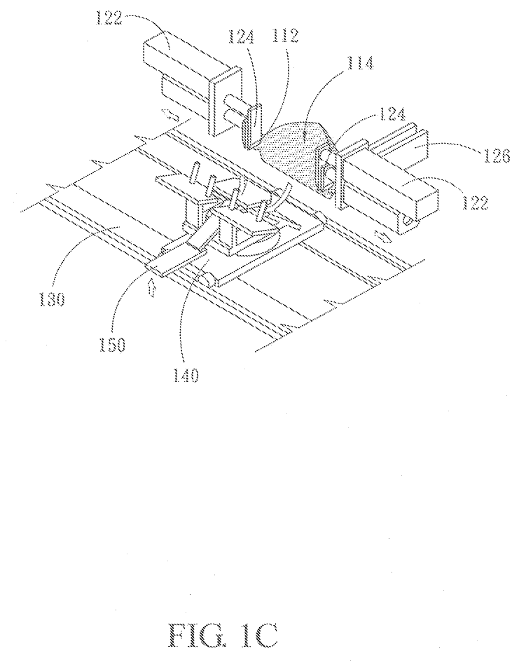

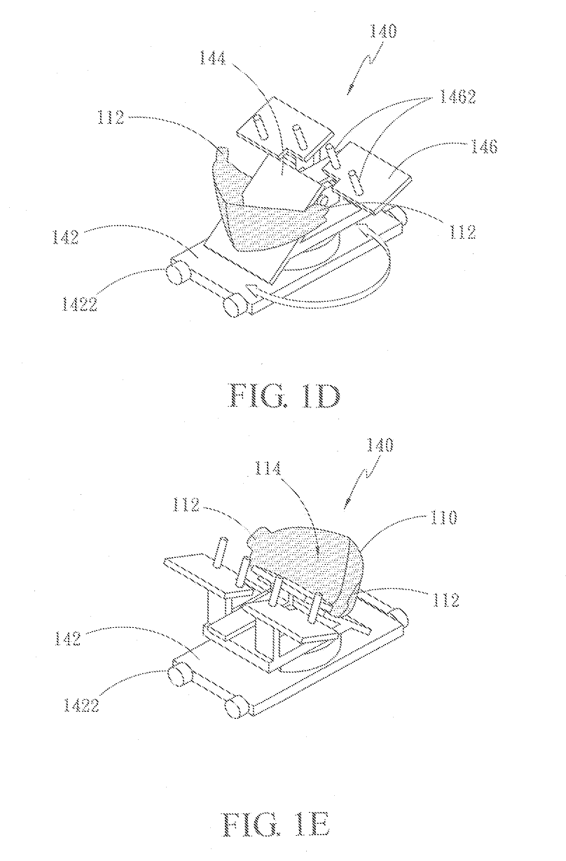

Referring to FIGS. 1A-1E, the mask spreading mechanism 120 and the mask holder 126 incorporated in the automatic sponge bonding apparatus in accordance with the present invention are illustrated. The mask holder 126 serves to support a mask 110 in a folded condition thereon. The mask spreading mechanism 120 comprises at least one spreading arm 122 and a clamp 124. The clamp 124 holds the folded mask 110 positioned on the mask holder 126, and the spreading arm 122 picks up the mask 110 and spreads the mask 110 to change the mask 110 to a spread condition, under which the mask 110 is then positioned on the conveyance carrier 140. The conveyance carrier 140 comprises a carrier chassis 142 and at least one roller 1422, which is coupled to the chassis 142 to allow movement of the carrier 140. A retention plate 144 is arranged on the chassis 142 for pressing and retaining the mask 110 on the carrier 140 in fee spread condition. Further, the carrier 140 comprises a rotation structure coupling between the chassis 142 and the retention plate 144 to allow relative rotation of the retention plate 144 with respect to the chassis 142.

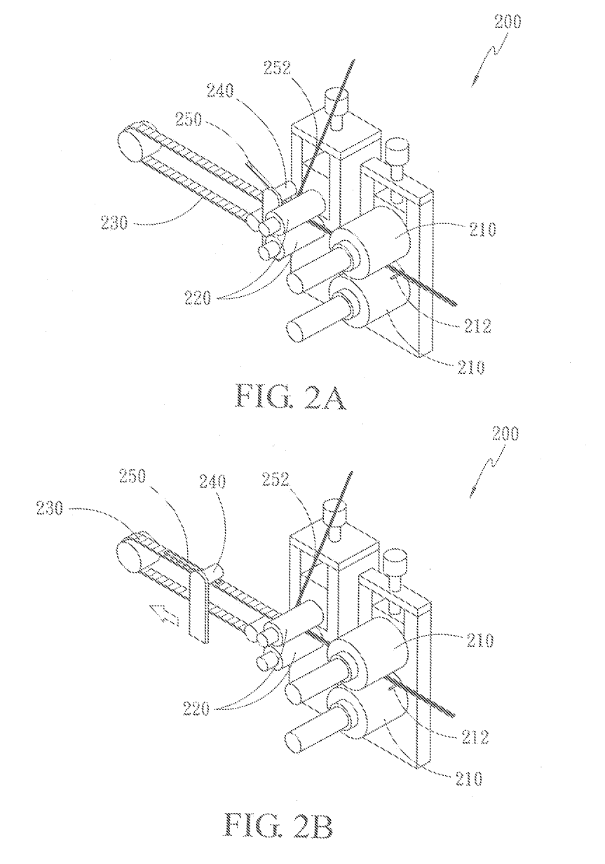

Referring to FIGS. 2A and 2B, the sponge cutting device 200 of the automatic sponge bonding apparatus in accordance with the present invention is illustrated. The sponge cutting device 200 serves to cut a length of sponge into cut pieces of sponge, which will also be referred to as a sponge member to be attached the face mask. The sponge cutting device 200 comprises at least one cut roller 210 and at least one forward roller 220. The cut roller 210 is provided with at least one cut blade 212. The forward roller 220 functions to drive a sponge member 250 and to separate a back adhesive release film 252 from a back adhesive layer of the sponge member 250. A conveyance belt 230 is arranged behind the forward roller 220 to convey a cut sponge piece 250. Further, at least one sponge retention bar 240 is arranged above the conveyance belt 230 for pressing and thus retaining the cut sponge piece 250 and to move in unison therewith. The sponge cutting device 200 allows for simultaneous cutting and providing cut pieces of sponge, leading to saving of time and labor.

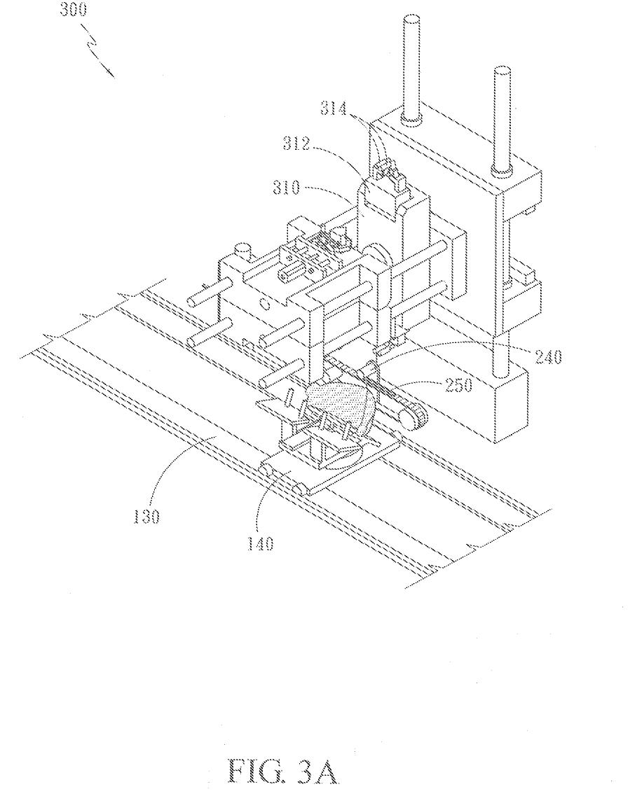

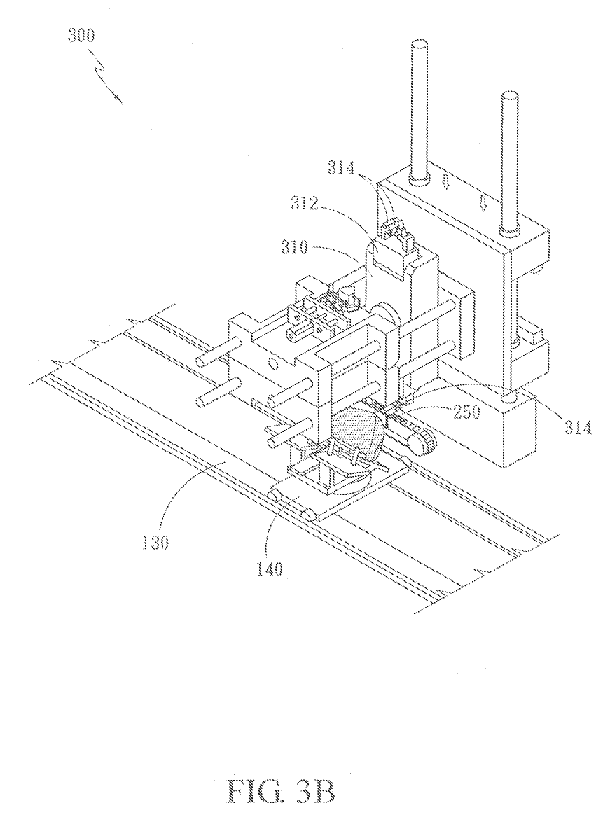

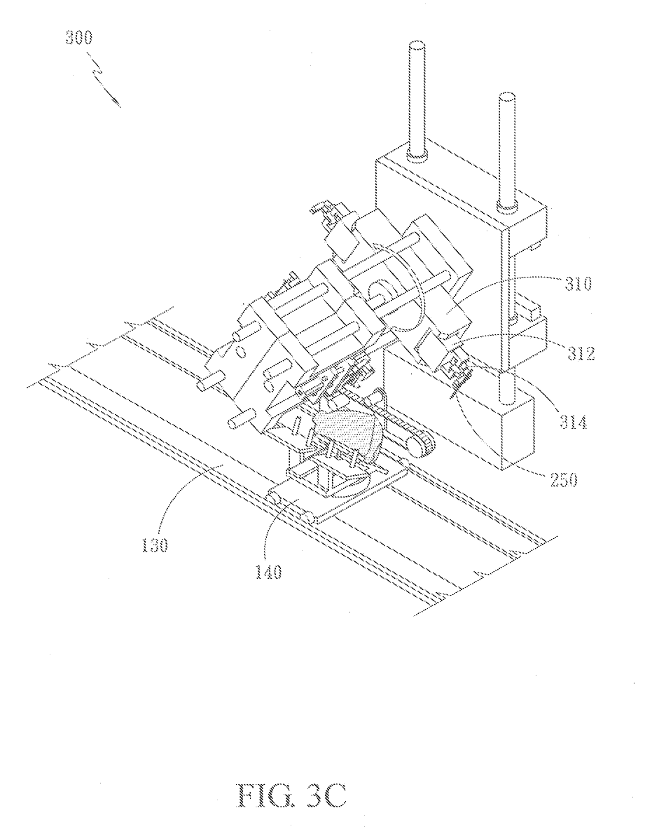

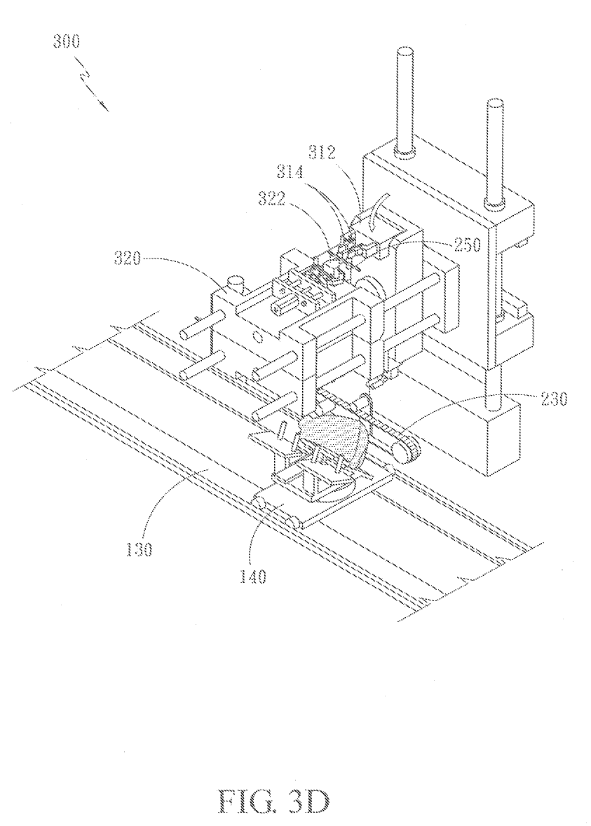

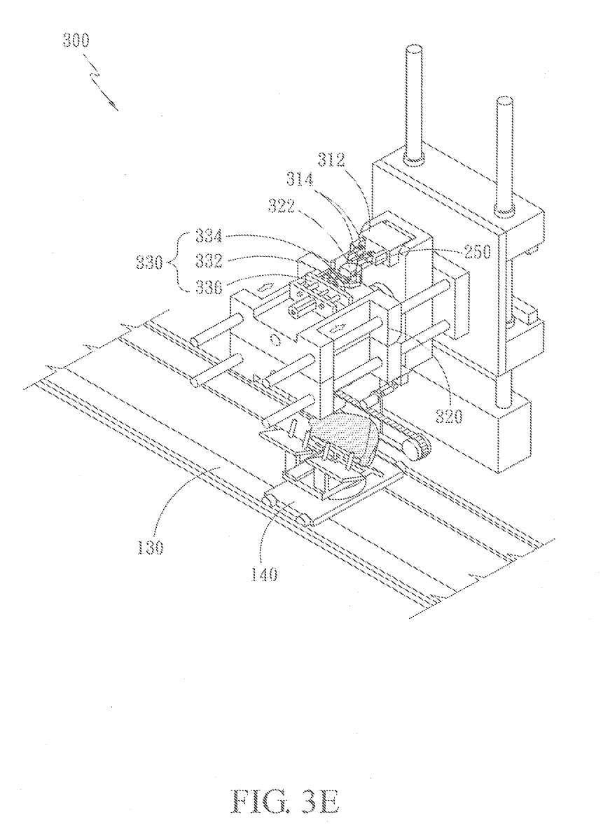

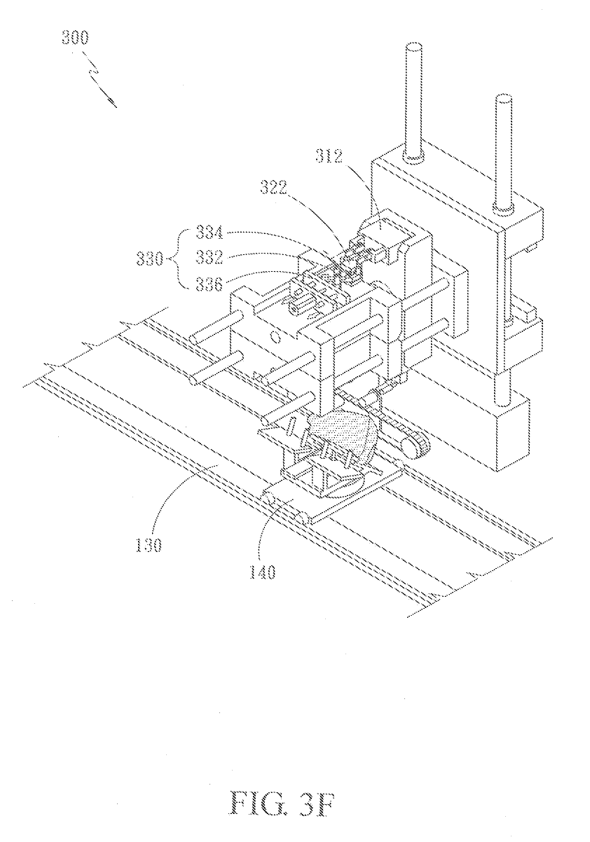

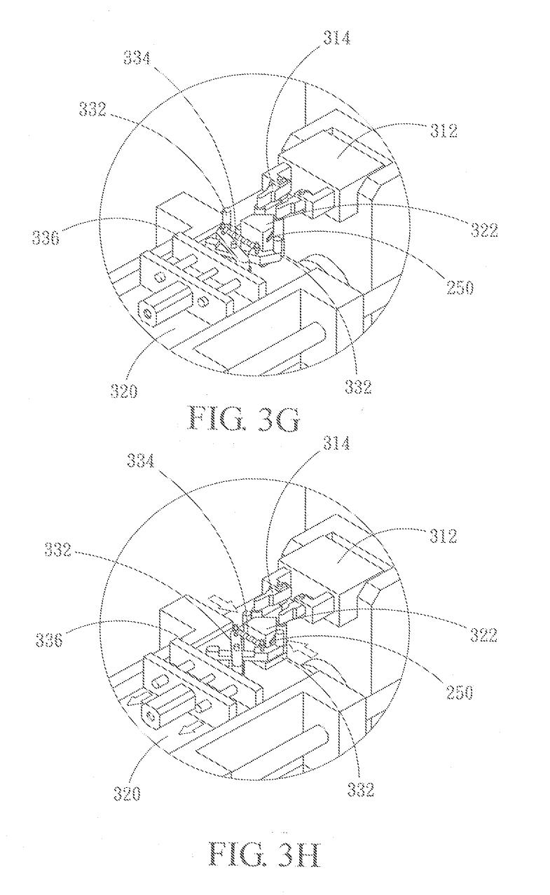

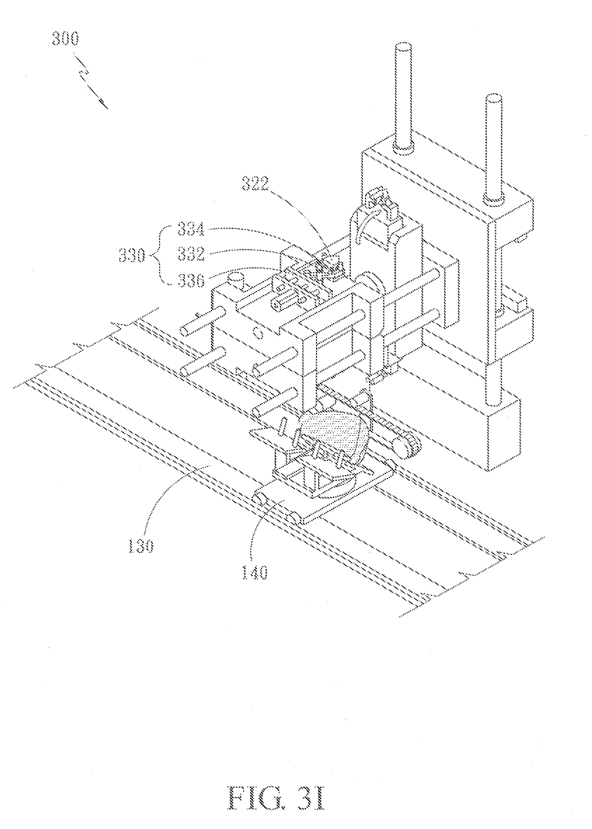

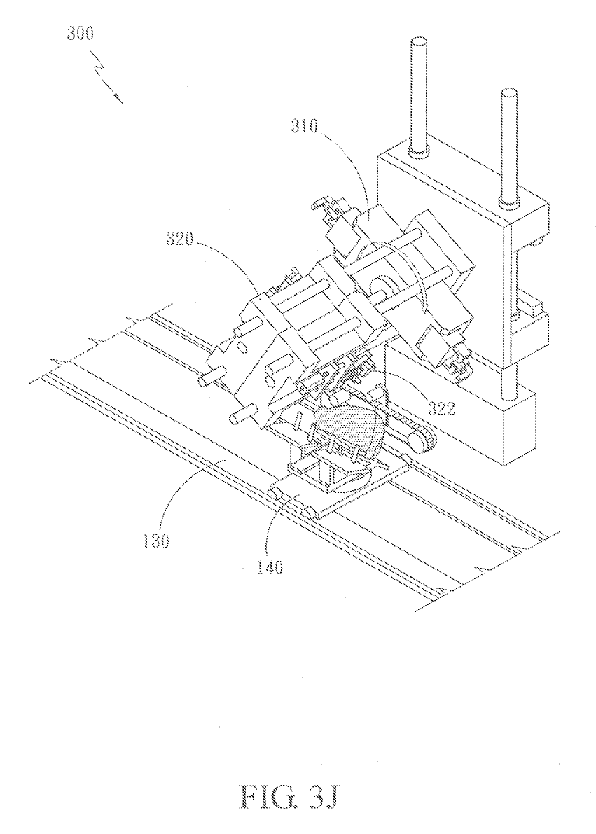

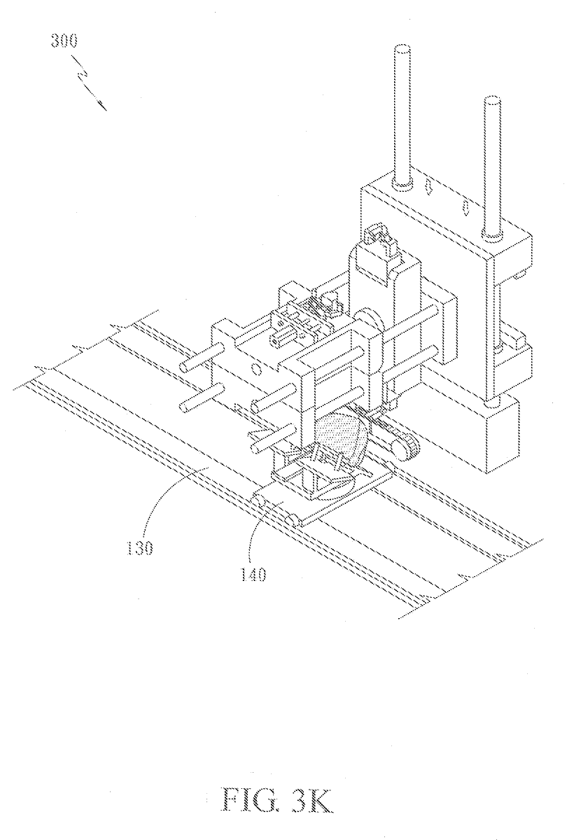

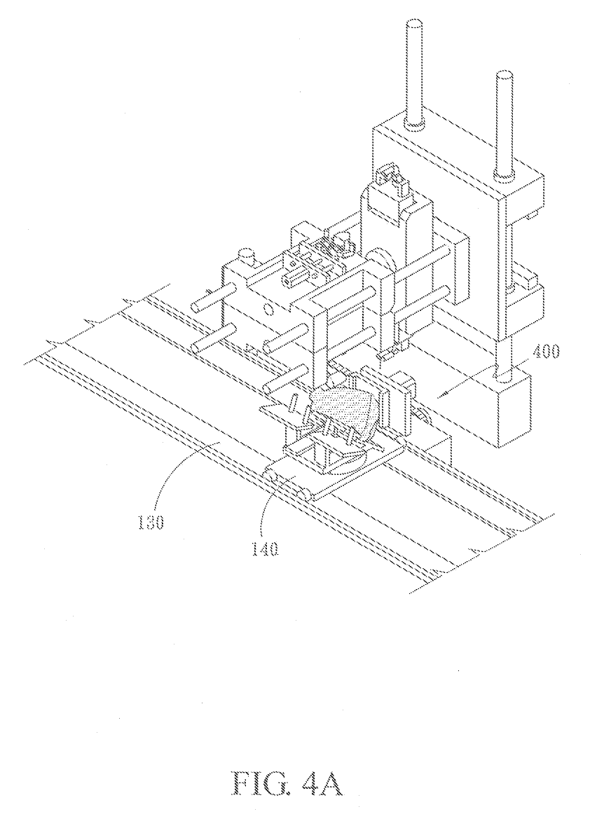

Referring to FIG. 3A-3K, the sponge pickup mechanism 300 is illustrated, which functions to pick up and transfer the cut piece of sponge 250. The sponge pickup mechanism 300 comprises a pickup frame 310, a pickup arm 312, a pickup clip 314, a shaped anvil slide 320, and a shaped, anvil 322. Further, a sponge holding mechanism 330 is provided by one side of the anvil 322, comprising a retention clamp 332, a resilient member 334, and a push board 336. The pickup clip 314 picks up the sponge 250 from the conveyance belt 230 first, and then the pickup frame 310 rotates to move the pickup clip 314 and the sponge retained on the pick up clip 314 upward. The pickup arm 312 is then rotated forward to a position facing the anvil 322. The push board 336 moves forward to push the anvil 322 toward the pickup clip 314 that carries the sponge 250 for depressing the sponge whereby the sponge is fixed by the retention clamp 332 of the sponge holding mechanism 330 and thus retained on the anvil 322. The resilient member 334 is coupled to the retention clamp 332 to make the retention clamp 332 resiliently hold the sponge.

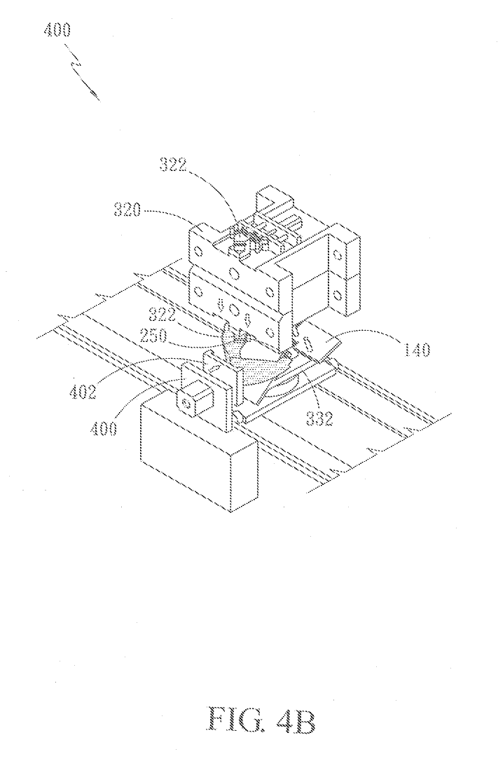

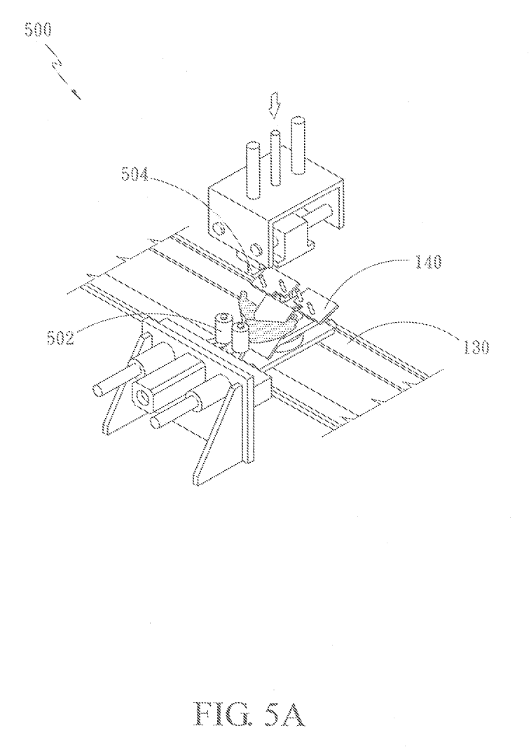

Referring to FIGS. 4A and 4B, the first sponge pressing mechanism 400 of the automatic sponge bonding apparatus in accordance with the present invention is illustrated. The first sponge pressing mechanism 400 comprises a press board 402. When the sponge holding mechanism 330 retains the sponge 250 on the anvil 322, the anvil slide 320 is rotated and moved downward to have the anvil 322 located on the inside of the mask. At the same time, the press board 402 is moved forward against, the mask 110 whereby the sponge 250 on the anvil 322 is adhesively attached, to the mask 110. The retention clamp 332 of the sponge holding mechanism 330 then releases the sponge 250 to leave the sponge 250 attached to the mask 110.

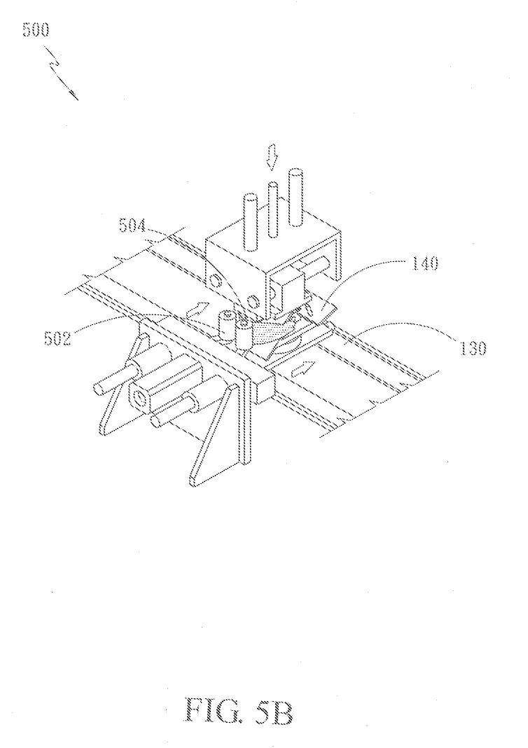

Referring to FIGS. 5A and 5B, the second sponge pressing mechanism 500 of the automatic sponge bonding apparatus in accordance with the present invention is illustrated. The second sponge pressing mechanism 500 comprises a pair of rollers 502 and a shaping board 504. When the carrier 140 moves along a track 130 to a location below the shaping board 504, the shaping board 504 is lowered down to the inside of the mask, while the rollers 502 are moved toward the mask to roll and press the mask against the shaping board 504 to more firmly attach the sponge 250 on the mask.

The present invention realizes firm attachment of the sponge 250 to the mask 11 by using the conveyance carrier 140 to transport the mask 110 and at the same time processing and providing the sponge 250, and completing the attachment of the sponge to the mask on the same operation platform, followed by twice pressing operation to ensure firm attachment of the sponge to the mask.

Although the present invention has been described with reference to the preferred embodiment thereof, it is apparent to those skilled in the art that a variety of modifications and changes may be made without departing from the scope of the present invention which is intended to be defined try the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automatic sponge bonding apparatus for a face mask comprising:
a conveyance carrier movable along a tracked arranged in an operation platform for conveying the face mask;
a sponge cutting device for cutting a length of sponge to provide
a piece of cut sponge;
a sponge pickup mechanism for picking up the cut sponge piece and transporting the cut sponge piece;
a first sponge pressing mechanism for pressing and thus attaching the cut sponge piece to the face mask; and
a press board arranged outside the carrier.

2. The automatic sponge bonding apparatus as claimed in claim 1 further comprising a mask holder and a mask spreading mechanism, wherein the mask holder serves to hold the face mask in a folded condition, and wherein the mask spreading mechanism comprises at least one spreading arm and a clamp for clamping on the face mask positioned on the mask holder and picking up and spreading the face mask to a spread condition, and then positioning the spread face mask on the carrier.

3. The automatic sponge bonding apparatus as claimed in claim 1, wherein the conveyance carrier comprises:
a carrier chassis;
at least one roller coupled to the chassis; and
a retention plat arranged on the chassis for pressing and retaining the face mask.

4. The automatic sponge bonding apparatus as claimed in claim 2, wherein the conveyance carrier comprises:
a carrier chassis;
at least one roller coupled to the chassis; and
a retention plat arranged on the chassis for pressing and retaining the face mask.

5. The automatic sponge bonding apparatus as claimed in claim 1, wherein the sponge cutting device comprises:
at least one cut roller, which is provided with at least one cut blade to cut the length of the sponge into the cut sponge piece;
at least one forward roller serving to drive the sponge and to separate a back adhesive release film from a back adhesive layer on the sponge;
a conveyance belt arranged behind the forward roller to convey the cut sponge piece; and
a sponge retention bar arranged above the conveyance belt for pressing and retaining the cut sponge piece.

6. The automatic sponge bonding apparatus as claimed in claim 2, wherein the sponge cutting device comprises:
at least one cut roller, which is provided with at least one cut blade to cut the length of the sponge into the cut sponge piece;
at least one forward roller serving to drive the sponge and to separate a back adhesive release film from a back adhesive layer on the sponge;
a conveyance belt arranged behind the forward roller to convey the cut sponge piece; and
a sponge retention bar arranged above the conveyance belt for pressing and retaining the cut sponge piece.

7. The automatic sponge bonding apparatus as claimed in claim 1, wherein the sponge pickup mechanism comprise a pickup frame, a pickup arm, and a pickup clip.

8. The automatic sponge bonding apparatus as claimed in claim 2, wherein the sponge pickup mechanism comprise a pickup frame, a pickup arm, and a pickup clip.

9. The automatic sponge bonding apparatus as claimed in claim 5, wherein the sponge pickup mechanism comprises a shaped anvil and a shaped anvil slide.

10. The automatic sponge bonding apparatus as claimed in claim 6 further comprising a sponge holding mechanism, which comprises a retention clamp, a resilient member, and a push board.

12. The automatic sponge bonding apparatus as claimed in claim 1 further comprising a second sponge pressing mechanism, which comprises a roller and a shaping board.

13. The automatic sponge bonding apparatus as claimed in claim 2 further comprising a second sponge pressing mechanism, which comprises a roller and a shaping board.
